(19) United States
(12) Patent Application Publication
(10) Pub. No.: US 2008/0048954 A1
(43) Pub. Date: Feb. 28, 2008

(54) APPARATUS AND METHOD FOR DISPLAYING OPERATION MODE OF KIMCHI REFRIGERATOR

(75) Inventors: Jong Kuk Lee, Cheonan-si (KR); Hee In Shin, Seoul (KR)

Correspondence Address: OCCHIUTI ROHLICEK & TSAO, LLP, 10 FAWCETT STREET, CAMBRIDGE, MA, 02138, US

(73) Assignee: WINIA MANDO INC., Chungcheongnam-do (KR)

(21) Appl. No.: 11/844,645

(22) Filed: Aug. 24, 2007

(30) Foreign Application Priority Data
Aug. 24, 2006 (KR) 10-2006-0080620
Aug. 24, 2006 (KR) 10-2006-0080801
Aug. 24, 2006 (KR) 10-2006-0080802
Aug. 24, 2006 (KR) 10-2006-0080803

(51) Int. Cl. G09G 3/32; G09G 3/36

(52) U.S. Cl. 345/82; 345/87

(57) ABSTRACT

An apparatus and a method for displaying an operation mode of a kimchi refrigerator are disclosed. The apparatus and method display information regarding food items stored in the kimchi refrigerator and operation information regarding operation modes of the food items. The method includes, if any one of the food items and an operation mode thereof are selected, selectively turning on an LED corresponding to the selected food item and an LED corresponding to the operation mode of the selected food item to indicate the selected food item and the operation mode of the selected food item, and controlling an LCD module to display information regarding the selected food item and operation information regarding the operation mode of the selected food item through an LCD panel. Information regarding food items and operation information regarding operation modes of the food items are displayed in various ways including texts and icons.

### BACKGROUND OF THE INVENTION

1. Field of the Invention

The present invention relates to a kimchi refrigerator, and more particularly to an apparatus and method for displaying an operation mode of a kimchi refrigerator, which can display information regarding food stored in the kimchi refrigerator and operation information regarding an operation mode of the food.

2. Description of the Related Art

In general, a kimchi refrigerator, which is a home appliance, has various operation modes associated with food. Each operation mode is selected by a key operation and then displayed using a display device such as a liquid crystal display (LCD) or light emitting diode (LED).

A display apparatus for displaying food and operation mode information comprises a microcomputer for controlling the driving of an LED and a mono type LCD, which are display devices, and LED and LCD driver integrated circuits (ICs) for driving the LED and LCD under the control of the microcomputer, respectively. With this configuration, a signal is outputted to a corresponding LED or LCD by a key operation so that information can be displayed.

However, nowadays, such a conventional display apparatus is complex in configuration and falls short of the current trend of techniques being toward a hybrid control system, so that it cannot take advantages of the hybrid control system and cannot help providing operation information being beyond the current techniques.

For this reason, the user may select an operation mode different from that desired by the user due to the user's poor common sense in operation modes. In this case, a kimchi refrigerator is operated in an operation mode not desired by the user, resulting in an undesired food state.

### SUMMARY OF THE INVENTION

Therefore, the present invention has been made in view of the above problems, and it is an object of the present invention to provide an apparatus and method for displaying an operation mode of a kimchi refrigerator, which can provide information regarding food stored in the kimchi refrigerator and operation information regarding an operation mode of the food in various ways.

It is another object of the present invention to provide an apparatus and method for displaying an operation mode of a kimchi refrigerator, which can display operation information regarding the operation mode in text and icon forms so that the user can accurately recognize the operation mode.

It is yet another object of the present invention to provide an apparatus and method for displaying an operation mode of a kimchi refrigerator, which can provide accurate operation information regarding the operation mode to the user so that the kimchi refrigerator can be prevented from being erroneously operated due to the user's poor common sense in operation modes and food can be stored in a desired way.

In accordance with an aspect of the present invention, the above and other objects can be accomplished by the provision of an apparatus for displaying an operation mode of a kimchi refrigerator, comprising: a key input unit for inputting key signals for various control commands; a flash memory for storing information regarding food items and operation information regarding operation modes of the food items; a display window including a food item display section for indicating the food items, and an operation mode display section for indicating the operation modes of the food items; a plurality of light emitting diodes (LEDs) installed in the food item display section and operation mode display section for individually lighting the food item display section and operation mode display section; a liquid crystal display (LCD) module for displaying the information regarding the food items and the operation information regarding the operation modes of the food items through an LCD panel; and a microcomputer for extracting, from the flash memory, information regarding one of the food items selected based on a key signal inputted from the key input unit and operation information regarding an operation mode of the selected food item selected based on a key signal inputted from the key input unit and outputting the extracted information to the LCD module, and turning on one of the LEDs in the food item display section corresponding to the selected food item and one of the LEDs in the operation mode display section corresponding to the operation mode of the selected food item.

The display window may be provided for each storage chamber of the kimchi refrigerator, and the LCD panel may be disposed between the display windows for the respective storage chambers.

The display windows may output the information regarding the selected food item and the operation information regarding the operation mode of the selected food item in the respective storage chambers.

The operation information regarding the operation modes of the food items may be stored in the form of JPEG type data including icons and texts.

If the operation mode of the selected food item is selected, the microcomputer may reduce brightness of a backlight for the LCD panel when a predetermined time has elapsed after the key input unit is operated.

The predetermined time may be 25 seconds.

In accordance with another aspect of the present invention, there is provided a method for displaying an operation mode of a kimchi refrigerator, the method displaying information regarding food items stored in the kimchi refrigerator and operation information regarding operation modes of the food items, the method comprising: if any one of the food items and an operation mode thereof are selected, selectively turning on an LED corresponding to the selected food item and an LED corresponding to the operation mode of the selected food item to indicate the selected food item and the operation mode of the selected food item, and controlling an LCD module to display information regarding the selected food item and operation information regarding the operation mode of the selected food item through an LCD panel.

The information regarding the selected food item and the operation information regarding the operation mode of the selected food item may be displayed in text and icon forms.

The information regarding the selected food item and the operation information regarding the operation mode of the selected food item may be displayed with animation.

The information regarding the selected food item and the operation information regarding the operation mode of the selected food item may be displayed until a predetermined time elapses after the selected food item and the operation mode of the selected food item are selected.

The predetermined time may be 25 seconds.

According to the present invention, information regarding food items stored in a kimchi refrigerator and operation information regarding operation modes set according to the types of the food items are displayed in various ways including texts and icons, so that the user can accurately recognize the operation mode operation information.

Further, accurate operation information regarding the operation modes is provided to the user. Therefore, the kimchi refrigerator can be prevented from being erroneously operated due to the user's poor common sense in operation modes and food can be stored in a desired way.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram showing the configuration of an apparatus for displaying an operation mode of a kimchi refrigerator according to an embodiment of the present invention;

FIG. 2 is a view showing an operation mode display panel of the kimchi refrigerator according to the embodiment of the present invention;

FIG. 3 is a flowchart illustrating a method for displaying the operation mode of the kimchi refrigerator according to the embodiment of the present invention; and

FIGS. 4, 5 and 6 are views showing operation mode display examples according to the embodiment of the present invention.

### DETAILED DESCRIPTION OF THE PREFERRED EMBODIMENTS

Now, preferred embodiments of the present invention will be described in detail with reference to the annexed drawings.

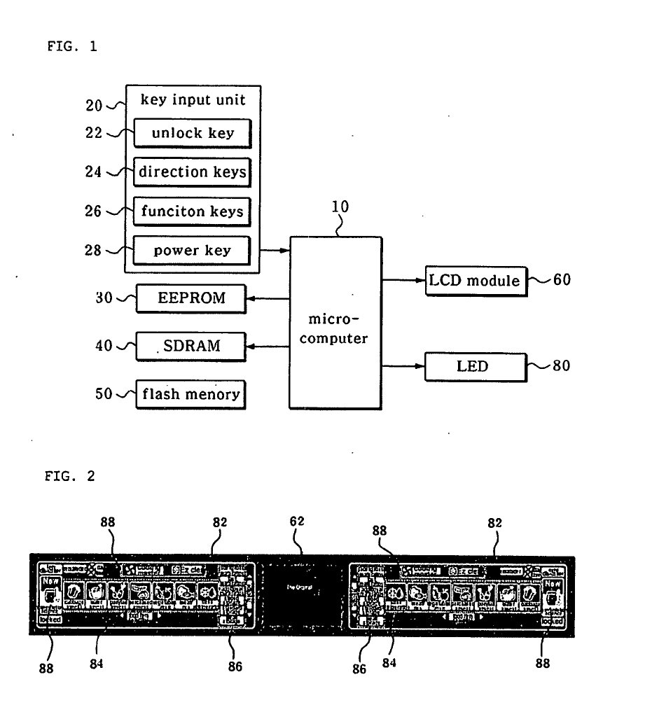

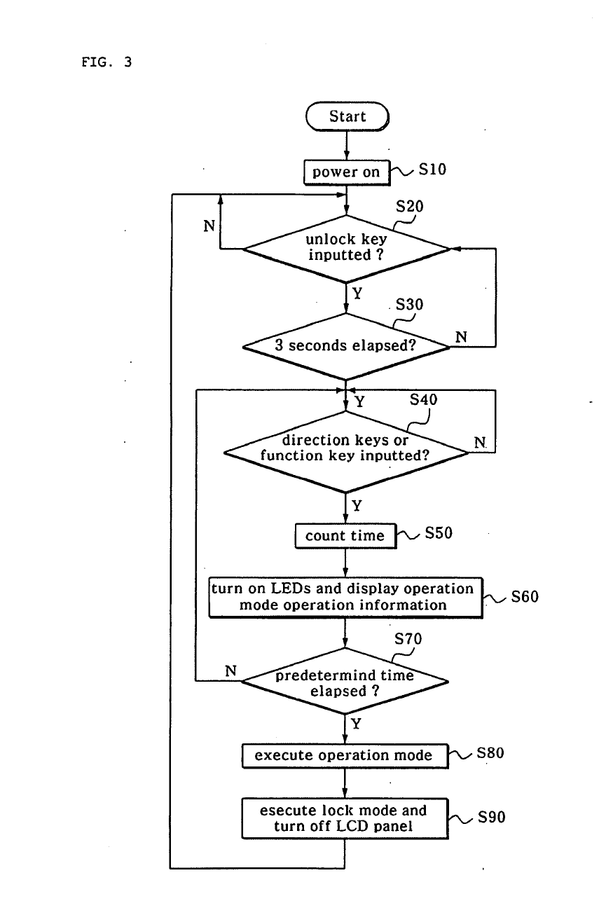

FIG. 1 is a block diagram showing the configuration of an apparatus for displaying an operation mode of a kimchi refrigerator according to an embodiment of the present invention, and FIG. 2 is a view showing an operation mode display panel of the kimchi refrigerator according to the embodiment of the present invention.

The operation mode display apparatus according to this embodiment comprises, as shown in FIG. 1, a microcomputer 10, a key input unit 20, an electrically erasable programmable read only memory (EEPROM) 30, a synchronous dynamic random access memory (SDRAM) 40, a flash memory 50, an LCD module 60, and LEDs 80.

The key input unit 20 acts to input various key signals based on the user's key operations. This key input unit 20 is installed on the front panel of the kimchi refrigerator so as to be easily operated by the user, and includes an unlock key 22, direction keys 24, function keys 26, and power keys 28.

The unlock key 22 functions to unlock a locked state of the kimchi refrigerator. In the present embodiment, if the unlock key 22 is continuously inputted for a predetermined unlock time, the kimchi refrigerator is unlocked.

The direction keys 24 include up and down keys (not shown), and left and right keys (not shown). The left and right keys function to select a food item, and the up and down keys function to select an operation mode of the food item selected by the left and right keys. Finally, the power keys 28 function to apply power to the kimchi refrigerator. These power keys 28 are provided for storage chambers of the kimchi refrigerator, respectively, to supply individual powers to the respective storage chambers.

In the present embodiment, the storage chambers of the kimchi refrigerator include a left chamber, right chamber, and drawer chamber, and the power keys 28 include a left chamber power key, right chamber power key, and drawer chamber power key for supplying individual powers to the left chamber, right chamber, and drawer chamber.

The EEPROM 30 stores a boot program for booting the kimchi refrigerator upon initial power supply, and the flash memory 50, which is of a NAND type, stores a control program of the microcomputer 10, operation mode information, and operation information regarding operation modes, for example, JPEG type data including icons and texts of various control functions. The SDRAM 40 acts to exchange data between the microcomputer 10 and the flash memory 50.

The LEDs 80 are turned on to indicate food items storable in the kimchi refrigerator and operation modes of the food items under the control of the microcomputer 10.

The LCD module 60 acts to display information regarding food items and operation information regarding an operation mode of each food item in various icons and texts under the control of the microcomputer 10. By the LCD module 60 displaying information regarding food items and operation information regarding an operation mode of each food item in icon and text forms, the user can easily recognize the food items and the operation modes of the food items.

For example, if the user selects ‘cabbage kimchi’ as a food item and ‘underground maturation’ as an operation mode of the ‘cabbage kimchi’, the LCD module 60 displays a text ‘slowly mature the cabbage kimchi at an underground temperature in winter season’, and an icon indicative of a cabbage kimchi being matured underground.

The microcomputer 10 functions to control the entire operation of the kimchi refrigerator according to the present embodiment. The microcomputer 10 controls a load, such as a compressor (not shown) installed inside the kimchi refrigerator, in response to a key signal inputted from the key input unit 20 to control a refrigeration cycle. The microcomputer 10 also performs a control operation to display information regarding food and operation information regarding an operation mode of the food.

That is, the microcomputer 10 controls a backlight unit (not shown) such that the backlight unit acts as a light source for an LCD panel (not shown). Also, the microcomputer 10 reads information regarding an inputted food item and operation information regarding an inputted operation mode of the food item from the flash memory 50 and displays the read information in text and icon forms through the LCD module 60.

In addition, if the direction keys 24 or function keys 26 are inputted, the microcomputer 10 selectively turns on LEDs 80 installed in a food item display section 84 which indicates a selected food item and in an operation mode display section 86 or 88 which indicates an operation mode of the selected food item, so that the user can easily recognize the selected food item and the operation mode thereof.

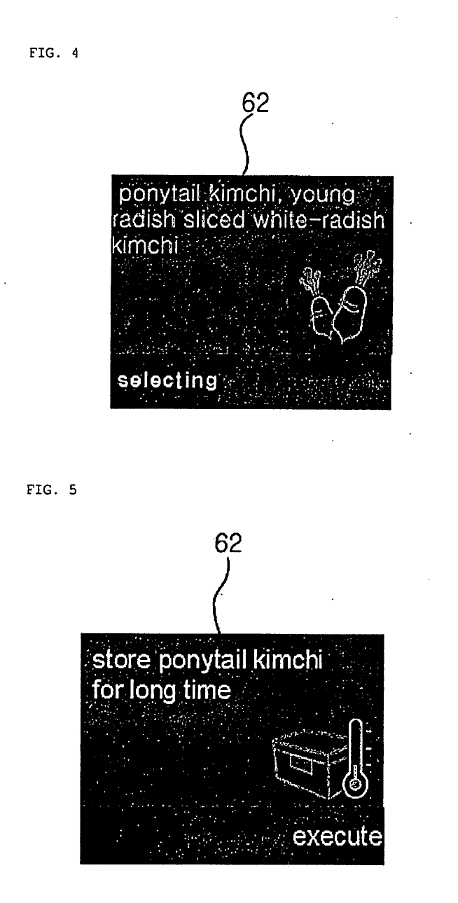

As described above, the microcomputer 10 controls the entire operation of the kimchi refrigerator operation mode display apparatus. The operation of the microcomputer 10 will be described in detail later with reference to FIG. 3 which illustrates an operation information display process.

The display panel of the kimchi refrigerator includes, as shown in FIG. 2, an LCD panel 62 for displaying information regarding food and operation information regarding an operation mode of the food. Display windows 82 are disposed at the left and right sides of the LCD panel 62.

The display windows 82 display information regarding food items stored in the corresponding storage chambers and operation information regarding operation modes of the food items so that the user can select desired ones of the food items and desired operation modes of the desired food items.

The LCD panel 62 selectively outputs information regarding food items stored in the left chamber, right chamber and drawer chamber and operation information regarding operation modes of the food items. For example, if the user selects a food item and an operation mode thereof in the left chamber to use the left chamber, the LCD panel 62 displays information regarding the food item in the left chamber and operation information regarding the operation mode of the food item in the left chamber. Conversely, if the user selects a food item and an operation mode thereof in the right chamber to use the right chamber, the LCD panel 62 displays information regarding the food item in the right chamber and operation information regarding the operation mode of the food item in the right chamber. This is applied to the drawer chamber in the same manner. Therefore, the user can conveniently recognize food items and operation modes thereof in the left chamber, right chamber and drawer chamber through one screen of the LCD panel 62.

On the other hand, a plurality of display sections are provided in the display windows 82. These display sections include the food item display section 84 and the operation mode display sections 86 and 88 as stated previously. The food item display section 84 displays information regarding food items in image and text forms so that the user can easily identify the food items. The operation mode display sections 86 and 88 display operation information regarding a general operation mode of a selected food item, and a special function such as fermentation science or defrost.

LEDs 80 are installed in the food item display sections 84 and the operation mode display sections 86 and 88 of the display windows 82. When a food item and an operation mode thereof are selected by the direction keys 24 of the key input unit 20, LEDs 80 corresponding to image of the selected food item and operation mode are turned on so that the user can easily recognize the selected food item and operation mode.

FIG. 3 is a flowchart illustrating a method for displaying an operation mode of the kimchi refrigerator according to the embodiment of the present invention.

First, under the condition that main power is supplied to the kimchi refrigerator (S10), the microcomputer 10 determines whether the unlock key 22 of the key input unit 20 is inputted (S20).

Upon determining that the unlock key 22 is inputted, the microcomputer 10 determines whether the unlock key 22 is continuously inputted for a predetermined unlock time, for example, three seconds (S30).

When the unlock key 22 is continuously inputted, the microcomputer 10 controls the LCD module 60 to display the remainder of the unlock time, preferably, in a second unit while the unlock key 22 is inputted. On the other hand, when the unlock key 22 is not inputted and the direction keys 24 or function key 26 is inputted, the microcomputer 10 displays the fact that the unlock key 22 must be inputted for three seconds.

Meanwhile, at the time that the unlock time, three seconds, have elapsed, the kimchi refrigerator is unlocked, and the left chamber power key, right chamber power key or drawer chamber power key is inputted to supply power to the left chamber, right chamber or drawer chamber to be used. Namely, power is supplied to the selected storage chamber.

If power is supplied to the selected storage chamber, the microcomputer 10 determines whether the direction keys 24 or function key 26 is inputted (S40). If the direction keys 24 or function key 26 is inputted, the microcomputer 10 counts time (S50), and extracts information regarding a currently selected food item, information regarding an operation mode of the selected food item and operation information regarding the operation mode of the selected food item from the flash memory 50 and outputs the extracted information to the LCD module 60 (S60).

The direction keys 24 include the up and down keys and the left and right keys, as stated previously. An LED 80 in the food item display section 84 is turned on according to the input of the left and right keys and a function selection icon of an operation mode of a currently selected food item in the operation mode display section 86 is lit according to the input of the up and down keys, so that the user can recognize the currently selected food item and the operation mode thereof.

If the separate function key 26 other than the aforementioned up and down keys and left and right keys is inputted to select a special function, for example, fermentation science, defrost or other operation mode, the microcomputer 10 turns on a corresponding LED 80 in the operation mode display section 88, and extracts operation information regarding the selected special function and displays the extracted operation information through the LCD module 60.

In the present embodiment, the food item display section 84 and the operation mode display section 86 are provided in each display window of the kimchi refrigerator shown in FIG. 2, as stated previously. The food item display section 84 displays food items such as ‘meat/fish’, ‘vegetables/fruit’, ‘purchased kimchi’, ‘ponytail kimchi’, ‘water kimchi’, and ‘cabbage kimchi’. In the operation mode display section 86, the user can select operation modes of the food items, for example, storage modes such as ‘strong storage’, ‘standard storage’ and ‘weak storage’, or maturation modes such as ‘underground maturation’, ‘fast maturation’ and ‘additional maturation’.

Where the user selects a food item using the left and right keys, the microcomputer 10 turns on a corresponding LED 80 in the food item display section 84 to light the selected food item in the food item display section 84, as shown in the display window 82. As a result, the user can recognize the currently selected food item.

On the other hand, after selecting the food item using the left and right keys 24, the user selects an operation mode of the selected food item using the up and down keys 24. If the user operates the up and down keys 24, the microcomputer 10 also turns on a corresponding LED 80 in the operation mode display section 86 to light the selected operation mode in the operation mode display section 86. As a result, the user can recognize the currently selected operation mode.

It should be noted here that certain operation modes are not applied to all food items. In this connection, when the user selects an operation mode through the up and down keys, the microcomputer 10 determines whether the selected operation mode is applicable to the currently selected food item and, only when the selected operation mode is applicable, turns on a corresponding LED 80 in the operation mode display section 86 to light the selected operation mode in the operation mode display section 86.

For example, where the user selects ‘vegetables/fruit’ as a food item, the kimchi refrigerator cannot be operated in the maturation modes, ‘underground maturation’, ‘fast maturation’ and ‘additional maturation’. Thus, the microcomputer 10 turns on only LEDs 80 for the operation mode display section 86 which indicate the storage modes, ‘strong storage’, ‘standard storage’ and ‘weak storage’.

That is, the microcomputer 10 turns on LEDs 80 corresponding to a selected food item and an operation mode thereof, as stated previously. As a result, the user can recognize respective food items and respective operation modes thereof through various icons.

In addition, when a food item is selected, the microcomputer 10 turns on an LED 80 corresponding to a standard mode set as a default for each operation mode.

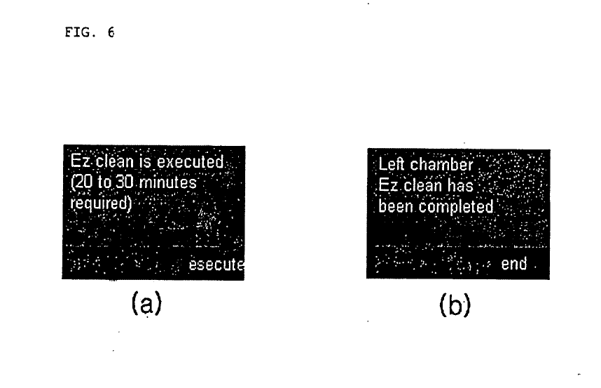

On the other hand, where a food item and an operation mode thereof is changed or selected through the up, down, right and left keys as stated above, the microcomputer 10 reads operation information regarding the changed or selected operation mode, namely, JPEG type data including texts from the flash memory 50 and outputs the read operation information to the LCD module 60, which then displays the operation information on the LCD panel 62, as shown in FIGS. 4 and 5.

FIGS. 4, 5 and 6 are views showing operation mode display examples according to the embodiment of the present invention.

FIG. 4 illustrates the selection of ‘ponytail kimchi’ as a food item using the left and right keys by the user. In this drawing, the ‘ponytail kimchi’, and ‘young radish kimchi’ and ‘sliced white-radish kimchi’ with similar storage characteristics to the ‘ponytail kimchi’ are displayed and an image corresponding to the ‘ponytail kimchi’ is together displayed in icon form.

Because the standard mode is set as a default for an operation mode when the food item is selected, the operation mode operation information shown in FIG. 4 is operation information of the standard mode.

FIG. 5 illustrates the selection of ‘strong storage’ as an operation mode of the ‘ponytail kimchi’ in FIG. 4. In FIG. 5, a text ‘store the ‘ponytail kimchi’ for a long time’, namely, operation information regarding the operation mode is displayed and operation information corresponding to the ‘strong storage’ is displayed in icon form (a storage box indicating that the storage chamber is maintained at a low temperature, and a thermometer indicating the low temperature of the storage box), so that the user can easily recognize the ‘strong storage’ mode.

Next, the selection of a special operation mode function will be described with reference to FIG. 6.

Where the user selects ‘defrost’ as a special function by operating the function key 26 of the key input unit 20, a text ‘Ez clean is executed (20 to 30 minutes required)’ is displayed as shown in FIG. 6A to indicate that an Ez clean function is performed. At the time that the defrost mode is completed, a text ‘Ez clean has been completed’ is displayed as shown in FIG. 6B to indicate that the Ez clean function has been completed. Therefore, the user can recognize the execution and completion of the defrost function.

In the above manner, when a food item and an operation mode thereof are selected, the microcomputer 10 executes the selected operation mode. Notably, after the direction keys 24 or function key 26 is operated to select or change the operation mode, the microcomputer 10 determines whether a predetermined time, preferably 25 seconds, have elapsed (S70). When the 25 seconds have elapsed, the microcomputer 10 executes the selected or changed operation mode by driving respective loads (not shown) of the kimchi refrigerator, for example, a step motor, compressor, heater, etc. while displaying an execution text as shown in FIG. 5 (S80).

The reason why the 25 seconds are set is that the 25 seconds are typically required for the user to recognize the operation information regarding the operation mode.

In addition, after the predetermined time has elapsed, the microcomputer 10 displays a text ‘execute’ as shown in FIG. 5 so that the user can recognize that the operation mode is executed. Moreover, until the predetermined time elapses after the food item and the operation mode thereof or the special function is selected by the input of the direction keys 24 or function key 26, the microcomputer 10 displays a text ‘selecting’ and arrows indicating that the predetermined time is elapsing, through an animation function, as shown in FIG. 4.

If the microcomputer 10 executes the operation mode selected by the user after the 25 seconds elapse, it executes a lock mode and controls the LCD module 60 to turn off the LCD panel 62 (S90). At this time, a backlight (not shown) for the LCD panel 62 may be controlled to gradually reduce the brightness of the LCD panel 62 so as to improve the image of a product.

At this time, the LEDs 80 are not turned off, so that the user can recognize food items currently stored in the storage chambers of the kimchi refrigerator and operation modes currently executed for the food items.

Thereafter, the microcomputer 10 continuously determines whether the unlock key 22 is inputted. If the unlock key 22 is continuously inputted for three seconds or more, the microcomputer 10 unlocks the locked state of the kimchi refrigerator and repeats the above procedure.

As apparent from the above description, according to the present invention, the kimchi refrigerator operation mode display apparatus can display information regarding food items and operation information regarding operation modes of the food items in icons and texts through LEDs and an LCD. Therefore, the user can conveniently use the kimchi refrigerator.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for displaying an operation mode of a kimchi refrigerator, comprising:
a key input unit for inputting key signals for various control commands;
a flash memory for storing information regarding food items and operation information regarding operation modes of the food items;
a display window including a food item display section for indicating the food items, and an operation mode display section for indicating the operation modes of the food items;
a plurality of light emitting diodes (LEDs) installed in the food item display section and operation mode display section for individually lighting the food item display section and operation mode display section;
a liquid crystal display (LCD) module for displaying the information regarding the food items and the operation information regarding the operation modes of the food items through an LCD panel; and
a microcomputer for extracting, from the flash memory, information regarding one of the food items selected based on a key signal inputted from the key input unit and operation information regarding an operation mode of the selected food item selected based on a key signal inputted from the key input unit and outputting the extracted information to the LCD module, and turning on one of the LEDs in the food item display section corresponding to the selected food item and one of the LEDs in the operation mode display section corresponding to the operation mode of the selected food item.

2. The apparatus according to claim 1, wherein the display window is provided for each storage chamber of the kimchi refrigerator, and the LCD panel is disposed between the display windows for the respective storage chambers.

3. The apparatus according to claim 2, wherein the display windows output the information regarding the selected food item and the operation information regarding the operation mode of the selected food item in the respective storage chambers.

4. The apparatus according to claim 1, wherein the operation information regarding the operation modes of the food items is stored in the form of JPEG type data including icons and texts.

5. The apparatus according to claim 1, wherein, if the operation mode of the selected food item is selected, the microcomputer reduces brightness of a backlight for the LCD panel when a predetermined time has elapsed after the key input unit is operated.

6. The apparatus according to claim 5, wherein the predetermined time is 25 seconds.

7. A method for displaying an operation mode of a kimchi refrigerator, the method displaying information regarding food items stored in the kimchi refrigerator and operation information regarding operation modes of the food items, the method comprising:
if any one of the food items and an operation mode thereof are selected, selectively turning on an LED corresponding to the selected food item and an LED corresponding to the operation mode of the selected food item to indicate the selected food item and the operation mode of the selected food item, and controlling an LCD module to display information regarding the selected food item and operation information regarding the operation mode of the selected food item through an LCD panel.

8. The method according to claim 7, wherein the information regarding the selected food item and the operation information regarding the operation mode of the selected food item are displayed in text and icon forms.

9. The method according to claim 7, wherein the information regarding the selected food item and the operation information regarding the operation mode of the selected food item are displayed with animation.

10. The method according to claim 7, wherein the information regarding the selected food item and the operation information regarding the operation mode of the selected food item are displayed until a predetermined time elapses after the selected food item and the operation mode of the selected food item are selected.

11. The method according to claim 10, wherein the predetermined time is 25 seconds.
